(19) United States
(12) Patent Application Publication
(10) Pub. No.: US 2024/0310667 A1
(43) Pub. Date: Sep. 19, 2024

(54) DISPLAY DEVICE, WATCH, AND DISPLAY DEVICE MANUFACTURING METHOD

(71) Applicant: CASIO COMPUTER CO., LTD., Tokyo (JP)

(72) Inventor: Eiji Yamakawa, Tokyo (JP)

(21) Appl. No.: 18/602,690

(22) Filed: Mar. 12, 2024

(30) Foreign Application Priority Data
Mar. 14, 2023 (JP) 2023-039630

(51) Int. Cl. G02F 1/133; G02F 1/1333; G02F 1/1335; G04C 10/02

(52) U.S. Cl. CPC G02F 1/13324; G02F 1/133308; G02F 1/133524; G04C 10/02; G02F 2201/38

(57) ABSTRACT

According to one embodiment, a display device includes: a solar panel; a circuit board on which electric components are arranged; an ODF liquid crystal panel arranged between the solar panel and the circuit board; and a connecting member arranged in a position which is in a vicinity of an outer peripheral portion of the ODF liquid crystal panel and is not in contact with the ODF liquid crystal panel, the connecting member being configured to connect the solar panel and the circuit board.

### CROSS-REFERENCE TO RELATED APPLICATIONS

This application is based upon and claims the benefit of priority from Japanese Patent Application No. 2023-039630, filed Mar. 14, 2023, the entire contents of which are incorporated herein by reference.

### FIELD

The present invention relates generally to a display device, a watch, and a display device manufacturing method.

### BACKGROUND

As disclosed in Jpn. Pat. Appln. KOKAI Publication No. 2021-148617, for a display device for use in a device such as a watch, etc., a configuration in which a liquid crystal display panel formed by stacking an LCD and a light guide plate is arranged to face a circuit board having various electronic components mounted thereon has been conventionally known. In such a display device, for example, in a case where a solar panel having a photovoltaic power generation element is arranged on a liquid crystal display panel, a board may be electrically connected to the photovoltaic power generation element of the solar panel with a spring in a coil shape. However, in such a case, arrangement of the liquid crystal display panel between the board and the photovoltaic power generation element causes a restriction on arrangement of a connecting member. For example, the connecting member needs to be arranged in such a manner as to avoid the liquid crystal display panel. This requires the photovoltaic power generation element to be increased in size as the liquid crystal display panel is made larger.

### SUMMARY

A display device according to an embodiment of the present invention includes: a solar panel; a circuit board on which electric components are arranged; an ODF liquid crystal panel arranged between the solar panel and the circuit board; and a connecting member arranged in a position which is in a vicinity of an outer peripheral portion of the ODF liquid crystal panel and in which the connecting member is not in contact with the ODF liquid crystal panel, the connecting member being configured to connect the solar panel and the circuit board.

### BRIEF DESCRIPTION OF THE DRAWINGS

FIG. 1 is a plan view of a watch according to a first embodiment of the present invention.

FIG. 2 is a view showing some portions of the watch.

FIG. 3 is a side view showing some portions of a display device of the watch.

FIG. 4 is a plan view showing a cover and a solar panel of the display device of the watch.

FIG. 5 is a plan view showing a partial configuration of the display device of the watch.

FIG. 6 is a plan view of a circuit board of the watch.

FIG. 7 is a view showing some portions of a display device according to a comparative example.

FIG. 8 is a plan view showing some portions of the display device according to the comparative example.

### DETAILED DESCRIPTION

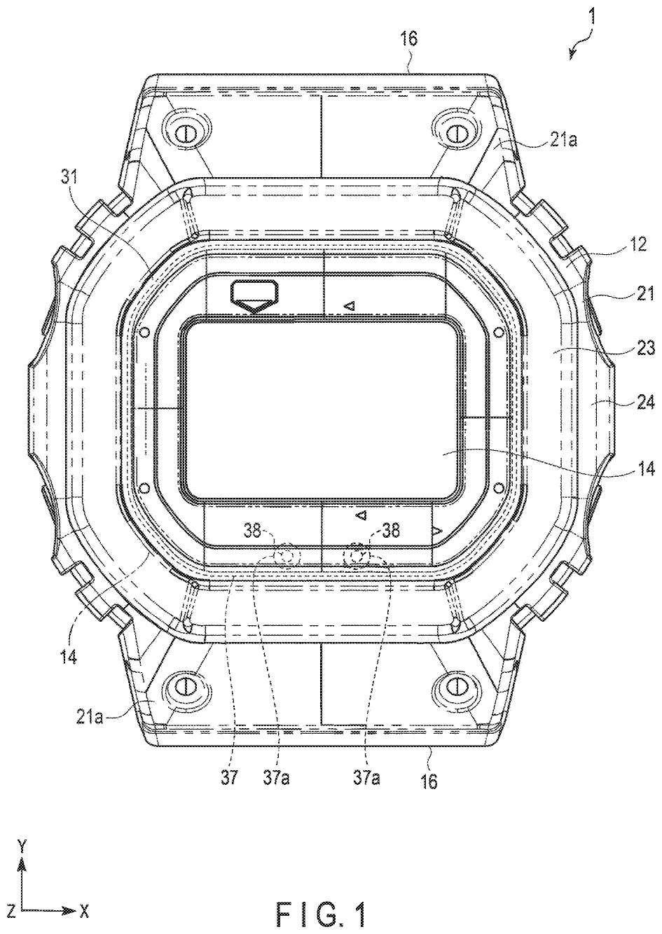

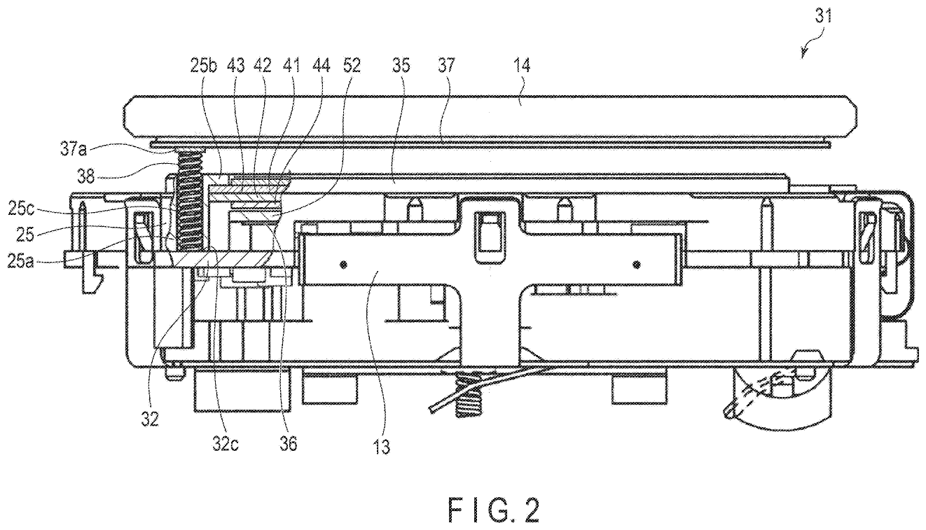

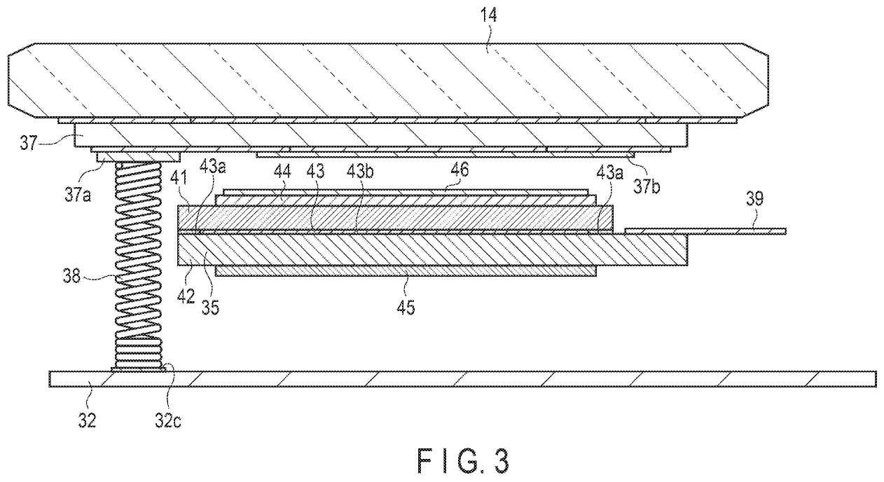

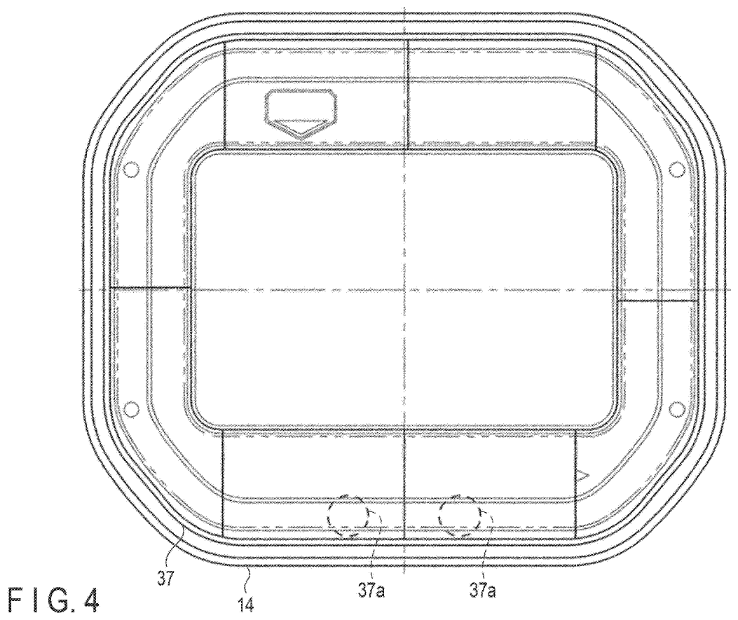

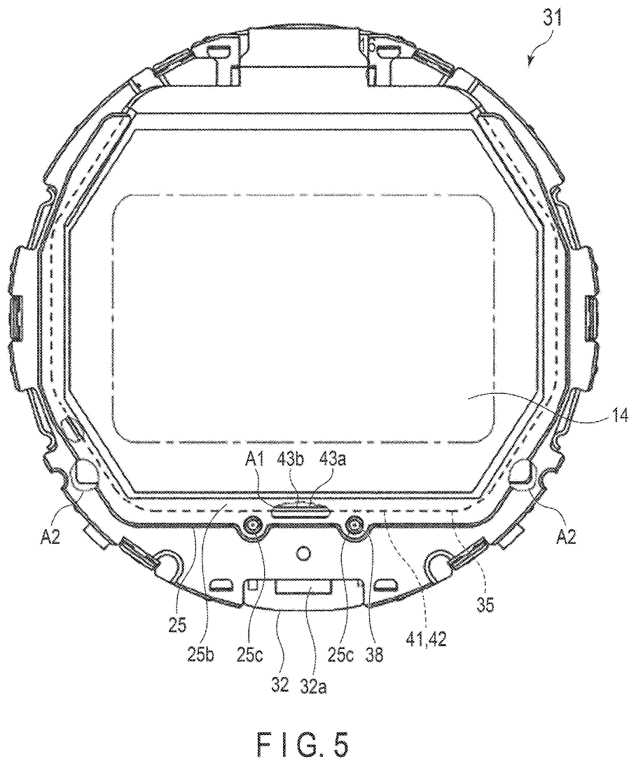

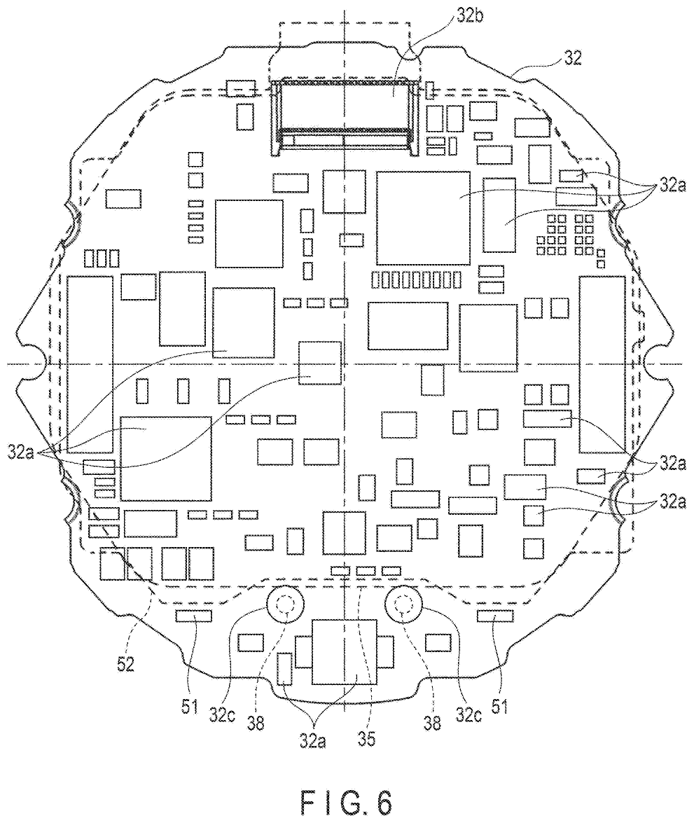

Hereinafter, a display device 31 and a watch 1 serving as a device according to a first embodiment of the present invention will be described with reference to FIG. 1 to FIG. 4. FIG. 1 is a plan view showing some portions of the watch 1 according to the first embodiment. FIG. 2 is a view illustrating some portions of the display device 31. FIG. 2 shows a cross section of an inner configuration with members in some regions omitted as appropriate. FIG. 3 is a side view showing some portions of the display device. FIG. 3 shows a schematic view with configurations enlarged, reduced, or omitted as appropriate for illustration. FIG. 4 is a plan view illustrating a configuration of a cover 14 and a solar panel 37. FIG. 5 is a plan view of some portions of the display device 31. FIG. 5 shows a partial inner configuration with a partial configuration cut out in some regions Al and A2. FIG. 6 is a plan view of a circuit board 32. The present embodiment describes an example case in which the display device 31 is applied to a dial plate of the watch 1. In the drawings, X, Y, and Z respectively indicate three directions that are perpendicular to each other. The description will assume that the X axis is a horizontal direction connecting 3 o'clock and 9 o'clock of the watch 1, the Y axis is a vertical direction connecting 12 o'clock and 6 o'clock of the watch 1, and the Z axis is a front and back direction and a stacking direction of the watch 1.

The watch 1 shown in FIG. 1 and FIG. 2 is, for example, a wristwatch, and includes a watch case 12 forming an outer shell, a watch module 13 provided inside the watch case 12, and a cover 14 covering a front side of the watch module 13. The watch 1 also includes a watch band 16 connected to two locations on the outer peripheral portion of the watch case 12, a plurality of switches arranged on the outer periphery of the watch case 12, and a clocking portion configured to clock current time.

The watch case 12 includes a housing 21 disposed around the outer peripheral portion of the watch module 13, a back cover arranged on the back side of the watch module 13, and an exterior case. The watch case 12 forms, by means of the housing 21 and the back cover, a container portion in which the watch module 13 is arranged. An opening on the front side of the housing 21 is covered with the cover 14. In the present embodiment, the watch case 12 is formed into an octagonal shape.

The housing 21 includes band attachment portions 21a at two locations facing each other on the outer peripheral portion, for example in the 6 o'clock and 12 o'clock positions, respectively, and the watch band 16 is attached to each of the band attachment portions 21a.

The housing 21 is made of metal or resin material. The housing 21 is formed into, e.g., an octagonal frame shape corresponding to the shape of the watch case 12. In the housing 21, the container portion that contains therein the watch module 13, etc., is formed. The housing 21 may be configured by combining a plurality of case members. For example, the housing 21 in the present embodiment is configured by assembling a main case member 24 and an inner case member 25 (inner case) provided on the inner peripheral edge of the main case member 24.

The main case member 24 is formed into, e.g., an octagonal annular shape corresponding to the shape of the watch case 12. The main case member 24 covers the outer peripheral portion of the watch module 13 and the inner case member 25. A waterproof ring that makes a gap between the main case member 24 and the back cover airtight is attached to the back-surface side of the main case member 24.

For example, the inner case member 25 is provided at the inner peripheral edge of the main case member 24 and supports a circuit board 32 and a display device 31 that correspond to some portions of the watch module 13. The inner case member 25 is formed into a shape corresponding to the shape of the watch case 12, for example, an octagonal frame shape.

As shown in FIG. 2, the inner case member 25 has a frame portion 25a arranged on the circuit board 32 and a cover wall 25b protruding to the inside from the frame portion 25a.

The frame portion 25a is a wall-shaped member that stands upright to the front side from the periphery portion on the circuit board 32. The frame portion 25a is arranged on an outer periphery of a liquid crystal display panel 35 (liquid crystal panel) or a lighting device 36.

The frame portion 25a is provided with supporting holes 25c each configured to support a coil spring. For example, the supporting hole 25c is a circular hole with its axis direction extending in the front and back direction of the watch, and a coil spring serving as a connecting member 38 is arranged in the supporting hole 25c. The pair of supporting holes 25c is formed in such a manner that they are at two locations in a position on the 6 o'clock side of the watch.

The cover wall 25b is a wall protruding to the inside in the radial direction from the end portion on the front side of the frame portion 25a, and faces the front side of the peripheral edge of the liquid crystal display panel 35. For example, the cover wall 25b is provided on at least a part of the inner peripheral edge of the inner case member 25. The cover wall 25b is perpendicular to the thickness direction of the display device 31 and the watch 1, is arranged to face the front-surface side of the peripheral edge of the liquid crystal display panel 35, is in contact with the peripheral edge of the liquid crystal display panel 35, and presses the liquid crystal display panel 35 toward the back-surface side. In the present embodiment, a first surface 25e is arranged to face the outer peripheral edge of a first electrode board 41 at the front side, which constitutes the liquid crystal display panel 35.

As shown in FIG. 1, the exterior case 23 is formed into, for example, an octagonal frame shape corresponding to the shape of the watch case 12, and is provided on the front side of the outer periphery of the housing 21. The exterior case 23 is fixed to the housing 21 by means of a connecting member such as a screw.

The watch module 13 shown in FIG. 2 includes the circuit board 32 and the display device 31 arranged on the front side of the circuit board 32 and configured to display various types of information such as time. The watch module 13 further includes a battery, various sensor components, and various other components necessary for the watch function. In the present embodiment, each of the display device 31 and the circuit board 32 arranged in a stacked manner is formed into an octagonal shape corresponding to the shape of the watch case 12, for example.

The circuit board 32 shown in FIG. 2, FIG. 3, FIG. 5, and FIG. 6 is a board provided with a predetermined wiring pattern and having a plurality of electronic components 32a mounted on its surface. The circuit board 32 is arranged to face a back-surface side of a light guide plate 52.

On the circuit board 32, the various electronic components 32a such as an IC serving as a drive portion configured to operate the display device 31, an antenna, etc., are equipped. Furthermore, a pair of LEDs serving as light emitting bodies 51 is formed in a region on the 6 o'clock side of the circuit board 32.

For example, in the present embodiment, a connecting terminal 32b for connecting a connector is arranged in the 12 o'clock position on one side in the vertical direction, as shown in FIG. 6. A solar connecting terminal portion 32c to which a pair of the connecting members 38 is connected is arranged on the 6 o'clock side as the other side in the vertical direction. The light emitting bodies 51 are respectively arranged on both side ends which are laterally outside of the solar connecting terminal unit 32c.

For example, the pair of connecting members 38 is arranged in a position overlapping the horizontal line connecting the pair of light emitting bodies 51 or is arranged in its vicinity.

Meanwhile, a relatively tall electronic component 32a is arranged in a region on the 6 o'clock side of the circuit board 32, which is outside of the connecting members 38 and is one side in the vertical direction because this region is not arranged to face the liquid crystal display panel 35. That is, the various electronic components 32a are arranged in such a manner that the outermost end portion of the electronic components 32a provided in the central region facing the liquid crystal display panel 35 is arranged in a position lower than the outermost end portion of the electronic components 32a provided in the outside region not facing the liquid crystal display panel 35. For example, a spacer configured to regulate a distance in the stacking direction from the light guide plate 52 of the lighting device 36 may be further arranged on the circuit board 32.

For example, as shown in FIG. 2 to FIG. 4, the display device 31 includes the liquid crystal display panel 35 of a transmissive type (the liquid crystal display panel), the lighting device 36, the solar panel 37, and the connecting members 38. For example, the display device 31 is a digital display unit and includes a digital display function.

As shown in FIG. 2 and FIG. 3, the liquid crystal display panel 35 includes a pair of a transparent first electrode board 41 (first board) and a transparent second electrode board 42 (second board) stacked in the front and back direction, a liquid crystal layer 43 arranged between the first electrode board 41 and the second electrode board 42, a pair of a first polarizing plate 44 stacked on the front surface of the first electrode board 41 and a second polarizing plate 45 stacked on the back surface of the second electrode board 42, and an optical sheet 46. The liquid crystal display panel 35 is an ODF (one drop fill) liquid crystal panel manufactured by the ODF method.

The pair of the transparent first electrode board 41 and the transparent second electrode board 42 are, for example, glass boards, and have transparent electrodes arranged in a matrix on their facing surfaces. An overlapping portion of the transparent electrodes of the first electrode board 41 and the second electrode board 42 forming a pair constitutes a pixel, so that pixels arranged in a matrix are formed. For example, the liquid crystal display panel 35 is electrically connected to the circuit board 32 and is given a drive signal from the circuit board 32 to display information electro-optically. That is, the liquid crystal display panel 35 displays information such as characters and patterns electro-optically by pixels arranged in a matrix being selectively shielded from light by selectively applying a voltage to the transparent electrodes of the first electrode board 41 and the second electrode board 42. For example, the lower electrode board 42 has the outer peripheral portion having a site on the 12 o'clock side protruding outward from the upper electrode board 41, in which a flexible board 39 is connected to this protruding site, and the connecting members 38 are arranged in the region on the opposite side in the vertical direction. This realizes effective utilization of a space formed on the 6 o'clock side by arranging, for example, the flexible board 39 on the 12 o'clock side opposite to the 6 o'clock side.

As shown in FIG. 3, the liquid crystal layer 43 includes a peripheral frame portion 43a made of an adhesive, and a liquid crystal material portion 43b surrounded by the peripheral frame portion 43a.

The peripheral frame portion 43a is made of an adhesive such as, for example, a UV curable paste. That is, by curing the adhesive supplied to the entirety of the periphery of either the first electrode board 41 or the second electrode board 42, the peripheral frame portion 43a covering the entirety of the periphery of the liquid crystal material portion 43b is formed.

The liquid crystal material portion 43b is made of a liquid crystal material. The liquid crystal material portion 43b is supplied to the inside of the peripheral frame portion 43a made of an adhesive. The liquid crystal material portion 43b according to the present embodiment is supplied before bonding, and is entirely housed in the peripheral frame portion 43a. Thus, the liquid crystal material portion 43b is stored inside the outer shape of the first electrode board 41 or the second electrode board 42 without protruding outside the outer shape of the board 41 or 42.

The second polarizing plate 45 constitutes the back side serving as the back surface of the liquid crystal display panel 35. The second polarizing plate 45 is placed in close contact with the front side of the lighting device 36 in such a manner as to face the lighting device 36.

The optical sheet 46 is an antireflection film. For example, the optical sheet 46 is a moth eye film commercially available as “MOSMITE”.

As shown in FIG. 2, for example, the first electrode board 41 on the front side of the liquid crystal display panel 35 is arranged to face the back side of the cover wall 25b of the inner case member 25 at the periphery, and the first polarizing plate 44 on the front side is arranged closer to the inner periphery side than the cover wall 25b of the inner case member 25.

The liquid crystal display panel 35 shown in FIG. 2 and FIG. 3 is formed by the ODF method. For example, after a peripheral frame portion is formed on the facing surface of the electrode board 41 or 42 by applying an adhesive to the entirety of the outer peripheral edge and a liquid crystal material is dropped within the peripheral frame portion, the other of the electrode boards 41 and 42 is overlapped and bonded to form the liquid crystal display panel 35 through UV temporary curing and real curing by heat.

As shown in FIG. 2 and FIG. 6, the lighting device 36 is provided on the back side of the liquid crystal display panel 35 and emits light from the back side of the liquid crystal display panel 35. The lighting device 36 includes the light emitting body 51 shown in FIG. 6 and the light emitting plate 52 shown in FIG. 2.

As shown in FIG. 6, the light emitting bodies 51 are mounted on the circuit board 32. The light emitting bodies 51 are provided on the outer peripheral side of the light guide plate 52 on the circuit board 32. Specifically, the light emitting bodies 51 are arranged to face one side portion of the light guide plate 52. For example, the plurality of light emitting bodies 51 are respectively arranged at two locations in the region on the 6 o'clock side, for example, the vicinities of the 5 o'clock and 7 o'clock positions. Each of the light emitting bodies 51 is, for example, a light emitting diode (LED) element, and emits light in the visible light range, such as white light. The light emitting body 51 is electrically connected to the circuit board 32.

The light emitting body 51 has a light source that emits light toward the end surface of the light guide plate 52. The light source is arranged at the center of the facing surface of the light emitting body 51, which faces the light guide plate 52. For example, in the present embodiment, the light source emits light from the end on the 6 o'clock side toward the 12 o'clock side.

For example, because of characteristics of a watch to be worn around an arm, it often happens that the 6 o'clock direction is located at a lower side and the 12 o'clock direction is located at an upper side due to an incline of the arm. Thus, the watch has characteristics wherein the visibility of its screen is enhanced in a case where light by the light emitting bodies 51 is made to enter from the 6 o'clock side. Therefore, in the present embodiment, the visibility of the screen can be enhanced by arranging the light emitting bodies 51 in the 6 o'clock direction.

The light guide plate 52 is made of a transparent or semi-transparent light transmitting material and is formed into a plate shape. For example, the light guide plate 52 is smaller than the outer shape of the circuit board 32 and faces the mounting area at the center of the circuit board 32.

Furthermore, as the outer shape is indicted by a broken line in FIG. 6, the light guide plate 52 is formed into a plate shape larger than the outer shape of the liquid crystal display panel 35. The light guide plate 52 is formed into, for example, an octagonal outer shape in a similar manner to the outer shape of the watch 1 or the circuit board 32. In the lower edge part as the 6 o'clock side of the light guide plate 52, two positions respectively facing the light emitting bodies 51 protrude toward the 6 o'clock side on both side portions which are laterally outside of the site in which the connecting members 38 are arranged.

The light guide plate 52 is provided with a predetermined light guide pattern configured to guide light from the light emitting bodies 51 in such a manner as to uniformly emit the light from the front-side surface, and is configured in such a manner as to emit an incident light from the upper surface (front surface).

Meanwhile, the lighting device 36 may be further provided with a reflection plate or a diffusion plate.

As shown in FIG. 2 to FIG. 4, the solar panel 37 is arranged to face the front-surface side of the liquid crystal display panel 35. The solar panel 37 is bonded to, for example, the back surface of the cover 14 via a bonding member such as a double-sided tape made of OCA, etc. The back-surface side of the solar panel 37 may be provided with, e.g., an optical sheet 37b such as a moth eye film, etc. In predetermined locations on the back-surface side of the solar panel 37, terminal portions 37a to be connected to the circuit board 32 via the connecting members 38 are formed. The terminal portions 37a are electrically connected to the circuit board 32 via the connecting members 38.

As shown in FIG. 1 to FIG. 3, FIG. 5, and FIG. 6, the connecting members 38 are provided in positions which are in the vicinity of the outer peripheral portion of the liquid crystal display panel 35 and in which the connecting members 38 are not in contact with the liquid crystal display panel 35. The connecting members 38 connect the solar panel 37 to the circuit board 32. For example, the connecting members 38 are respectively arranged on both end sides with the vertical line connecting 12 o'clock to 6 o'clock being the center in a region on the 6 o′clock side of the watch. The connecting members 38 are, for example, coil springs, and are formed to have a diameter substantially constant from one end to the other end. The connecting members 38 are contained in the supporting holes 25c formed in the frame portion 25a, and are supported by the supporting holes 25c. Each of the connecting members 38 electrically connects the solar panel 37 and the circuit board 32 by one end being pushed onto the terminal portion 37a of the solar panel 37 and the other end being pushed onto the circuit board 32. For example, the distance between the connecting members 38 and the outer periphery of the ODF liquid crystal display panel 35 is smaller than the thickness, which is the dimension in the first direction, of the peripheral frame portion 43a.

The cover 14 shown in FIG. 1 to FIG. 4 is a transparent member made of, for example, inorganic glass such as SiO2 glass. For example, the cover 14 is a transparent watch glass formed into an octagonal shape, and is placed on the front side of the watch module 13 to cover the watch module 13. For example, the cover 14 is supported on the inner peripheral edge of the opening on the front side of the housing 21. A packing is interposed between the outer periphery of the cover 14 and the inner peripheral edge of the housing 21.

As a method of manufacturing the watch according to the present embodiment, the liquid crystal display panel 35 is configured by the ODF method in which, first, as shown in FIG. 3, a liquid crystal material is dropped within the peripheral frame portion 43a of the first electrode board 41 in which the peripheral frame portion 43a is formed on the entirety of the outer peripheral portion, and the first electrode board 41 and the second electrode board 42 are arranged to face each other and are bonded together. Meanwhile, the electrode boards 41 and 42 may be switched. For example, the peripheral frame portion 43a may be bonded to the second electrode board 42, and the first electrode board 41 may be bonded after dropping of the liquid crystal material. Thereafter, the liquid crystal display panel 35 is arranged on the front side of the circuit board 32, the solar panel 37 is arranged on the front side of the liquid crystal display panel 35, and the connecting member 38 connecting the circuit board 32 and the solar panel 37 is arranged on the outer peripheral portion of the liquid crystal display panel 35 on the circuit board 32.

The display device 31 according to the present embodiment is configured in such a manner that the liquid crystal material is housed within the peripheral frame portion 43a by producing the liquid crystal display panel 35 by the ODF method, not the sealing method. This configuration can prevent a sealing member from protruding from the liquid crystal board in an arrangement, so that the connecting members 38 for connecting the solar panel 37 and the circuit board 32 can be arranged in the vicinity of the outer surface of the liquid crystal display panel 35. This realizes effective utilization of a space and miniaturization of a device.

A display device manufacturing method adopts a sealing method in which a pair of liquid crystal boards is arranged to face each other and their peripheral edge portion is surrounded by a frame partially provided with an opening serving as a liquid inlet through which a liquid crystal material is injected to be enclosed and cured in a space between the liquid crystal boards forming the pair. With such a configuration in which the liquid inlet for injecting the liquid crystal material is formed, a sealing member for sealing the liquid inlet is formed on the outer peripheral portion of the liquid crystal boards in such a manner as to protrude from the outer peripheral portion. This makes it more difficult to arrange the connecting members and reduces the degree of freedom in arranging components including the connecting members within the device.

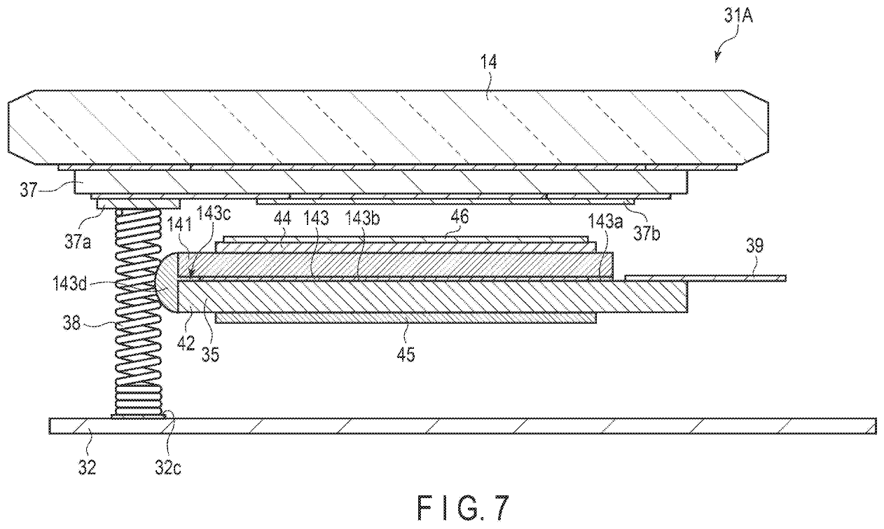

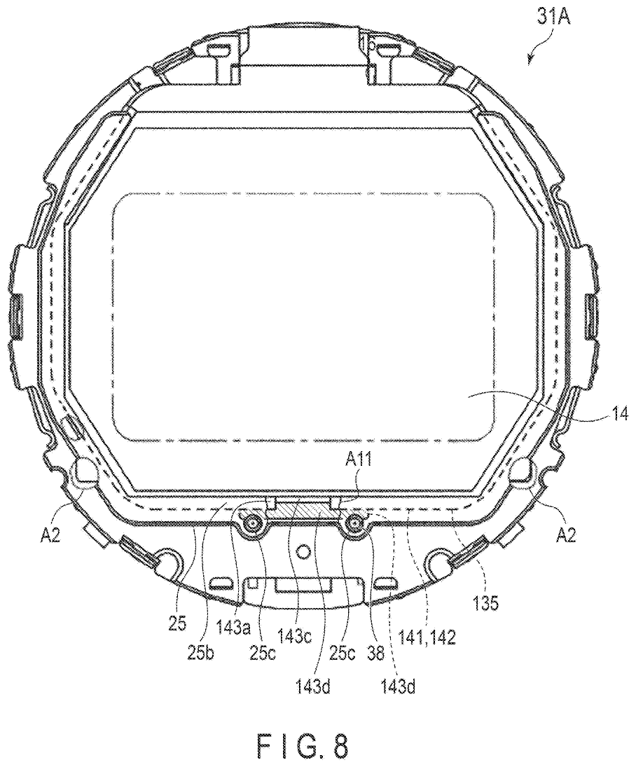

FIG. 7 and FIG. 8 are each a view illustrating a partial configuration of a display device 31A according to a comparative example. FIG. 7 shows a schematic view with configurations enlarged, reduced, or omitted as appropriate for illustration. FIG. 8 is a plan view showing a partial configuration of the display device 31A according to the comparative example. For illustration, FIG. 8 shows an inner configuration with members appropriately omitted in some regions A11 and A12. For illustration, furthermore, FIG. 7 and FIG. 8 each indicate a sealing material 143d by hatching. For example, the display device 31A illustrated as the comparative example in FIG. 7 and FIG. 8 includes a liquid crystal display panel 135 formed by the sealing method. For example, the liquid crystal display panel 135 according to the comparative example is configured by forming the liquid crystal material portion by injecting the liquid crystal material through a liquid inlet 143c included in a sealing portion 143a with a first electrode board 141 and a second electrode board 142 being bonded together with the sealing portion 143a intervening therebetween, and after forming the liquid crystal material portion, by supplying the sealing material 143d to the liquid inlet 143c to seal it. That is, as indicated by hatching in FIG. 7 and FIG. 8 for illustration, the liquid crystal display panel 135 is provided with the sealing material 143d protruding outward from the first electrode board 141 and the second electrode board 142. The sealing material 143d provided to protrude from the electrode boards 141 and 142 as described above interferes with the connecting members 138, thereby restricting a space in which the connecting members 138 are arranged. On the other hand, because a light emitting body (LED) is arranged in the display device 31A, the connecting members 138 need to be provided in positions in which they interfere with sealing material 143d, thereby making it difficult to arrange the components. In contrast, the liquid crystal display panel 35 according to the embodiment has no sealing material 143d to secure a space in which the connecting members 38 can be arranged, thereby realizing the high degree of freedom in arranging other peripheral components or various electronic components 32a.

Furthermore, the liquid crystal display panel 35 according to the embodiment can secure a space for the connecting members 38, thereby being able to mitigate the restrictions on a shape of the connecting members. For example, in a case where there is no arrangement space, an expensive connecting member such as a flexible board needs to be used; however, an inexpensive coil spring can be arranged in the liquid crystal display panel 35 according to the embodiment. This realizes the liquid crystal display panel 35 at low cost, requires little space, and reduces the number of installation man-hours. Further, the liquid crystal display panel 35 according to the present embodiment can make the outer shape of the solar panel smaller than that of the configuration including the sealing material 143d.

In the above embodiment, the liquid crystal display panel 35 has a configuration that includes the boards 41 and 42, the peripheral frame portion 43a surrounding the entirety of the outer peripheral edge of the facing surface, and the liquid crystal material portion 43b contained in the peripheral frame portion 43a, and has no need for sealing by means of the sealing member and has no protruding portion at the outer peripheral portion.

In the above embodiment, the connecting members 38 are coil springs extending in the stacking direction of the solar panel 37 and the circuit board 32, and are realized at low cost because they are simpler in configuration than those having a configuration in which the connection is made by bypassing the members using, for example, a flexible board. Furthermore, each coil spring is configured to have a diameter substantially constant from one end to the other end, and an inexpensive member is applicable.

In the configuration according to the above embodiment, a distance between the outer periphery of the liquid crystal display panel 35 and the connecting member 38 is smaller than the thickness of the peripheral portion 43a configured to seal the liquid crystal material, and the device can be further miniaturized.

The device is configured in such a manner that the inner case member 25 having the supporting hole 25c in which the coil spring is contained is provided in the vicinity of the outer peripheral portion of the liquid crystal panel 35 on the front side of the circuit board 32, and the coil springs serving as the connecting members 38 are easily installed.

The device is configured in such a manner that the connecting members 38 are arranged on one side in the vertical direction of the circuit board 32 and the connecting terminal 32b to which the flexible board 39 is connected is arranged in the other side, so that a space can be effectively utilized.

Since the lighting device 36 includes the light guide plate 52 arranged on a side closer to the solar panel 37 and facing the circuit board 32, and the light emitting bodies 51 arranged on the circuit board 32 and facing the side portion of the light guide plate 52, the lighting device 36 can be provided by effectively utilizing a space on the circuit board 32.

Furthermore, the display device 31 is formed by the ODF method in which the liquid crystal material is dropped within the peripheral frame portion 43a of the boards 41 and 42 each having the outer peripheral portion provided with the peripheral frame portion 43a, and the boards 41 and 42 are arranged to face each other and are bonded together. By arranging the display device 31 and the solar panel 37 on the circuit board 32 and arranging the connecting members 38 on the outer peripheral portion, a method of manufacturing a miniature and inexpensive device can be provided.

The embodiment is discussed merely as an example, which should not be considered to restrict the scope of invention.

For example, the above embodiment described the watch 1 as an example of the device; however, this is not a limitation. The present invention is applicable to other devices such as a calculator including a solar panel. Furthermore, the features in a plurality of embodiments may be combined.

Some embodiments of the present invention have been described; however, the scope of the present invention 10 is included within the scope of the invention described in the claims and their equivalents.

What is claimed is:

1. A display device comprising:
a solar panel;
a circuit board on which electronic devices are arranged;
an ODF liquid crystal panel arranged between the solar panel and the circuit board; and
a connecting member arranged in a position which is in a vicinity of an outer peripheral portion of the ODF liquid crystal panel and in which the connecting member is not in contact with the ODF liquid crystal panel, the connecting member being configured to connect the solar panel and the circuit board.

2. The display device according to claim 1, wherein the ODF liquid crystal panel comprises:
a first board;
a second board arranged to face the first board;
a peripheral frame portion configured on an outer peripheral edge of a facing surface of the first board or the second board and surrounding an entirety of the outer peripheral edge; and
a liquid crystal material to be contained within the peripheral frame portion.

3. The display device according to claim 1, wherein the connecting member is a coil spring extending in a stacking direction of the solar panel and the circuit board.

4. The display device according to claim 3, wherein the coil spring has a diameter substantially constant from one end to another end.

5. The display device according to claim 2, wherein a distance between an outer periphery of the ODF liquid crystal panel to the connecting member is smaller than a thickness of the peripheral frame portion.

6. The display device according to claim 3, further comprising an inner case which is provided in the vicinity of the outer peripheral portion of the ODF liquid crystal panel, on a side closer to the solar panel of the circuit board, and which has a supporting hole in which the coil spring is contained.

7. The display device according to claim 1, wherein the connecting member is arranged on one side of the circuit board, and
a connecting terminal to which a flexible board is connected is arranged on another side of the circuit board.

8. The display device according to claim 1, further comprising a lighting device, wherein the lighting device includes a light guide plate arranged on a side closer to the solar panel to face the circuit board, and a light emitting body arranged on the circuit board and arranged to face a side portion of the light guide plate.

9. A watch comprising:
the display device according to claim 1;
an exterior case; and
a clocking portion provided inside the exterior case and configured to clock current time.

10. A display device manufacturing method comprising:
configuring an ODF liquid crystal display panel by an ODF method in which an liquid crystal material is dropped within a frame portion of a first board having an outer peripheral portion provided with the peripheral frame portion and a second board is arranged to face the first board and is bonded together;
arranging the ODF liquid crystal panel between a solar panel and a circuit board; and
arranging a connecting member in a position which is a vicinity of an outer peripheral portion of the ODF liquid crystal panel and in which the connecting member is not in contact with the ODF liquid crystal panel, the connecting member being configured to connect the solar panel and the circuit board.
